(19) United States
(12) Patent Application Publication
(10) Pub. No.: US 2004/0184753 A1
(43) Pub. Date: Sep. 23, 2004

(54) Fiber module in which optical fiber coated with metal or inorganic material is fixed to sealable package so that an end of the optical fiber appears inside the package

(75) Inventors: Yuichi Teramura, Kanagawa-ken (JP); Yoji Okazaki, Kanagawa-ken (JP); Teruhiko Kuramachi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/767,207

(22) Filed: Jan. 30, 2004

(30) Foreign Application Priority Data
Jan. 31, 2003 (JP) 024889/2003

(51) Int. Cl. G02B 6/22

(52) U.S. Cl. 385/128; 385/94

(57) ABSTRACT

A fiber module includes: a package having a structure which allows sealing of the inside of the package; and an optical fiber having a predetermined length and being fixed to the package in such a manner that the first end of the optical fiber appears inside the package. The cladding is exposed (bare) in a vicinity of the second end, and the optical fiber other than a portion of the cladding in the vicinity of the second end is coated with at least one of a metal and an inorganic material.

### BACKGROUND OF THE INVENTION

1. Field of the Invention

The present invention relates to a fiber module comprised of a package containing, for example, a light-emitting element or a light-receiving element, and an optical fiber which is fixed to the package so that an end of the optical fiber appears inside the package. In addition, the present invention also relates to a method for producing a fiber module as described above.

2. Description of the Related Art

The following document (1) discloses information related to the present invention.

(1) U.S. Patent Laid-Open No. 20020090172

Conventionally, optically-multiplexing laser-light sources which generate a laser beam having an ultraviolet wavelength are known, for example, as disclosed in the above document (1). Such optically-multiplexing laser-light sources comprise a plurality of semiconductor lasers contained in a package, an optical fiber which is fixed to the package so that an end of the optical fiber appears inside the package, and an optical condensing system which couples laser beams emitted from the plurality of semiconductor lasers, to the optical fiber.

Generally, fiber modules in which a light-emitting element or a light-receiving element is contained in a package and an optical fiber coupled to the light-emitting element or the light-receiving element is led out of the package, are called pigtail type fiber modules, and are widely used in the fields of optical communications and the like.

Incidentally, bare optical fibers are sensitive to flaws, and flawed optical fibers are prone to break. Therefore, optical fibers are normally coated for protection. The commercially available optical fibers are covered with a primary coating made of an ultraviolet-light-curing resin and arranged outside the cladding and a secondary coating made of a polymer and arranged outside the primary coating.

In order to stably maintain a state in which an optical fiber is coupled to a light-emitting element or light-receiving element with precision on the order of micrometers, it is necessary to firmly fix the optical fiber to the package. Generally, the optical fibers are fixed by using a solder or an adhesive.

However, if optical fibers which are covered with the primary coating are fixed, the accuracy of the fixed position decreases due to heat damage to the coating caused by soldering, deterioration of the coating, or the like. Therefore, normally, the primary coating is removed by a chemical etching process, and an operation called metalizing is performed. In the metalizing operation, the bare fiber is coated by forming a thin metal film over the cladding by sputtering or plating. The purpose of the metalizing is to prevent damage to a bare strand of optical fiber (which is constituted by only a core and a cladding) and enhance affinity with a soldering material in the operation for fixation.

The optical fibers metalized as above are inferior to the optical fibers covered with the primary coating in the effect of preventing damage and the tensile strength. In addition, since the metalizing process is highly expensive, only the minimum necessary portion (normally having a width of about 25 mm or less) of each optical fiber is metalized. That is, the primary coating is left in the major portion of each conventional optical fiber located outside the package.

Incidentally, in general apparatuses using a laser, if dust, an evaporated organic material, or the like is suspended in the air of the use environment, materials can be deposited on a laser-emission end facet or a laser-condensing end facet due to an organic photochemical reaction of the substance suspended in air and a laser beam. It is known that the lifetime of the laser is reduced when the above deposition occurs, and the reduction in the lifetime increases with decrease in the wavelength or increase in the output power. In particular, the above reduction is pronounced when a GaN-based compound semiconductor laser having an oscillation wavelength of about 400 nm is used. In a laser module having high optical intensity, the optical intensity becomes particularly high at a facet of a semiconductor laser element or at a facet of a fiber. Therefore, the effects of dust deposition on these facets are conspicuous. In a laser module that multiplexes a plurality of laser beams, emitted from semiconductor laser elements, into a single fiber, the optical intensity becomes high at the fiber facet. Therefore, the effects of dust deposition on this facet are conspicuous.

In order to prevent the above reduction in the lifetime in the pigtail type laser modules as mentioned before, hermetically sealing a package containing optical components including a semiconductor laser and an optical fiber after the semiconductor laser and the optical fiber are optically aligned with each other and fixed, is being considered. In addition, it is known that the effect of preventing the reduction in the lifetime is enhanced by degassing the inside of the module immediately before sealing of the package. Generally, the degassing process is performed by placing the entire module to be sealed, in a furnace provided in a degassing system.

However, if the fiber coating made of an organic material exists in the furnace during the degassing process, one or more components are exhaled from the coating by the degassing, and the inside of the package is contaminated with the exhaled components, i.e., the situation becomes worse. Further, in the conventional fiber module as mentioned before, the primary coating is left in the major portion of the partially metalized optical fiber located outside the package. Therefore, one or more components are exhaled from the primary coating by the degassing.

Although a conceivable method of preventing the above contamination is to remove the entire coating, this method is not practical since uncoated optical fibers are prone to break. In addition, although another conceivable method is to use a special optical fiber coated with a polyimide, such a special optical fiber is highly expensive, so that use of such a special optical fiber greatly increases the cost of the fiber module.

Although the problems occurring in the conventional fiber modules are explained by examples in which a light-emitting element is contained in a package, similar problems can also occur in fiber modules in which a light-receiving element is contained in a package. Further, similar problems can also occur in fiber modules in which neither light-receiving elements nor light-receiving elements are contained in a package, and a portion of an optical fiber including a light-emission end of the optical fiber is contained in the package for protection of the light-emission end.

### SUMMARY OF THE INVENTION

The present invention has been developed in view of the above circumstances.

A first object of the present invention is to provide a fiber module which can be produced at low cost, and in which the inside of a package is not contaminated with a material exhaled from a coating of an optical fiber by degassing, and the optical fiber has sufficient mechanical strength.

A second object of the present invention is to provide a method by which the above fiber module can be produced.

(I) In order to accomplish the first object, the first aspect of the present invention is provided. According to the first aspect of the present invention, there is provided a fiber module comprising: a package having a structure which allows sealing of the inside of the package; and an optical fiber having a predetermined length and being fixed to the package in such a manner that a first end of the optical fiber appears inside the package. The cladding of the optical fiber is exposed (bare) in a vicinity of a second end, and the optical fiber other than the portion of the cladding in the vicinity of the second end is coated with at least one of a metal and an inorganic material.

In order to accomplish the first object, the second aspect of the present invention is also provided. According to the second aspect of the present invention, there is provided a fiber module comprising: a package having a structure which allows sealing of the inside of the package; and an optical fiber having a predetermined length and being fixed to the package in such a manner that a first end of the optical fiber appears inside the package. The cladding of the optical fiber is exposed (bare) in vicinities of the first end and a second end, and the optical fiber other than the portions of the cladding in the vicinities of the first and second ends is coated with at least one of a metal and an inorganic material.

In the fiber modules according to the first and second aspects of the present invention, the first end of the optical fiber may protrude from an inner surface of a wall of the package, or be flush with or slightly recessed from the inner surface of the wall.

It is desirable that the package is hermetically sealed by flux free solder, an adhesive that does not contain Si organic materials, by fusion, or by welding.

It is further desirable that the interior of the package is filled with an inert gas. It is desirable that at least one of a halogen gas, a halide gas, and oxygen at a concentration of 1 ppm or greater is included in the inert gas. That is, it is desirable that the internal atmosphere of the package is one of (1) a mixed gas containing an inert gas and oxygen at a concentration of 1 ppm or greater; (2) a mixed gas containing an inert gas and at least one of a halogen gas and a halide gas; and (3) a mixed gas containing an inert gas, oxygen at a concentration of 1 ppm or greater, and at least one of a halogen gas and a halide gas.

Preferably, the fiber modules according to the first and second aspects of the present invention may also have one or any possible combination of the following additional features (i) to (iii).

(i) Light-emitting elements and/or light-receiving elements are contained in the package, and are optically coupled to the first end of the optical fiber.

(ii) In the fiber modules having the feature (i), the package may contain: semiconductor lasers for emitting a plurality of laser beams, provided as the light-emitting elements; a plurality of collimator lenses which collimate divergent laser beams emitted from the plurality of semiconductor lasers, respectively; and a condensing lens which condenses the collimated laser beams, and makes the collimated laser beams converge on an end face of a core of the optical fiber at the first end. In this case, an apparatus which generates a high-power optically-multiplexed laser beam is obtained.

(iii) In the fiber modules having the feature (ii), it is desirable that the semiconductor lasers are one of:

a plurality of single cavity semiconductor laser elements aligned in an array;

a single multi cavity semiconductor laser element;

a plurality of multi cavity semiconductor laser elements aligned in an array; and a combination of single cavity semiconductor laser elements and multi cavity semiconductor laser elements.

The present invention is particularly suited for fiber modules wherein the oscillation wavelengths of the semiconductor lasers are in the rance of 350 to 500 nm.

The first and second aspects of the present invention have the following advantages.

In the fiber module according to the first aspect of the present invention, the cladding of the optical fiber is exposed (bare) in the vicinity of the second end, and the optical fiber other than the portion in the vicinity of the second end is coated with at least one of a metal and an inorganic material. That is, the optical fiber is reinforced and protected by the coating with the metal or the inorganic material. Therefore, the conventional coating made of an organic material is unnecessary for normally handling the optical fiber. Thus, even when the degassing operation is performed on the fiber module according to the first aspect of the present invention in a furnace of a degassing system, the inside of the package is not contaminated with a component exhaled from the coating of the optical fiber by the degassing.

The above advantages are obtained even in the fiber module according to the second aspect of the present invention in which the cladding is also exposed in the vicinity of the first end.

In particular, when the package in each of the fiber modules according to the first and second aspects of the present invention contains light-emitting elements and/or light-receiving elements, which are optically coupled to the first end of the optical fiber, it is possible to prevent contamination of the light-emitting elements and/or light-receiving elements, and improve operational stability and reliability.

Further, when the present invention is applied to an optically-multiplexing fiber module in which the package contains: a plurality of semiconductor lasers for emitting a plurality of laser beams; a plurality of collimator lenses which collimate divergent laser beams emitted from the plurality of semiconductor lasers, respectively; and a condensing lens which condenses the collimated laser beams, and makes the collimated laser beams converge on an end face of a core of the optical fiber at the first end, it is possible to prevent contamination of various elements in the package, and stably maintain the output power of the optically-multiplexed laser beam high.

As mentioned before, when the oscillation wavelengths of semiconductor lasers in an optically-multiplexing fiber module are 350 to 500 nm, the elements in the package are prone to contamination. Therefore, the effect of stably maintaining the output power of the optically-multiplexed laser beam high becomes pronounced in the case where the plurality of semiconductor lasers in the optically-multiplexing fiber module have an oscillation wavelength of 350 to 500 nm.

In addition, according to the first and second aspects of the present invention, substantially no component is exhaled from the coating of the optical fiber by degassing. Therefore, the partial pressure of components exhaled in the degassing system during a degassing process is reduced, and the effect of the degassing process is enhanced.

Although the coating made of a metal or an inorganic material is less advantageous than the conventional primary and secondary coatings in the effect of suppressing damage and the tensile strength, the optical fiber becomes unlikely to break by connecting a conventional optical fiber to the aforementioned second end the vicinity of which is exposed, and providing appropriate reinforcement, after the degassing and sealing of the package are completed.

Further, since the optical fiber partially coated with a metal or an inorganic material according to the present invention can be produced at lower cost than the aforementioned optical fiber coated with polyimide, the fiber modules according to the present invention using the optical fiber coated with a metal or an inorganic material as above can be produced without substantial increase in cost, i.e., at a relatively low cost.

(II) In order to accomplish the aforementioned second object, the third aspect of the present invention is provided. According to the third aspect of the present invention, there is provided a method for producing a fiber module which includes a first optical fiber having a predetermined length, comprising the steps of: (a) exposing a portion of the cladding in a vicinity of a first end of the first optical fiber, and coating the first optical fiber other than the exposed portion with at least one of a metal and an inorganic material; (b) fixing the first optical fiber to a package having a structure which allows sealing of an inside of the package, in such a manner that a second end of the first optical fiber appears inside the package; (c) degassing the inside of the package; and (d) hermetically sealing the package.

In the method according to the third aspect of the present invention, it is possible to surely prevent contamination of the inside of the package with a component exhaled from the organic-resin coating of an optical fiber by degassing.

In order to accomplish the aforementioned second object, the fourth aspect of the present invention is also provided. According to the fourth aspect of the present invention, there is provided a method for producing a fiber module which includes a first optical fiber having a predetermined length, comprising the steps of: (a) exposing a portion of the cladding in a vicinity of a first end, and coating the first optical fiber other than the exposed portion with at least one of a metal and an inorganic material; (b) fixing the first optical fiber to a package containing at least one of light-emitting elements and light-receiving elements and having a structure which allows sealing of an inside of the package, in such a manner that a second end of the first optical fiber appears inside the package, and the first optical fiber is optically coupled to the at least one of light-emitting elements and light-receiving elements at the second end; (c) degassing the inside of the package; and (d) hermetically sealing the package.

In the method according to the fourth aspect of the present invention, it is possible to surely prevent contamination of the at least one of light-emitting elements and light-receiving elements in the package with a component exhaled from the organic-resin coating of an optical fiber by degassing, and produce a fiber module which is superior in operational stability and reliability.

Preferably, the methods according to the third and fourth aspects of the present invention may also have one or any possible combination of the following additional features (iv) and (v).

(iv) The methods according to the third and fourth aspects of the present invention may further comprise the step of coupling the first end of the first optical fiber to a second optical fiber being coated with a resin and having a predetermined length, after the step (d).

In this case, the second optical fiber does not exist during the degassing process. Therefore, it is possible to prevent contamination of the optical elements (e.g., the at least one of light-emitting elements and light-receiving elements) in the package with a component exhaled from the coating of the second optical fiber.

(v) The methods having the feature (iv) may further comprise the step of at least partially reinforcing a portion of the fiber module between a wall of the package and the second optical fiber by using a reinforcing member.

In this case, it is possible to make the optical fibers in the fiber module unlikely to be damaged during normal use.

### BRIEF DESCRIPTION OF THE DRAWINGS

FIG. 1 is a side view of a fiber module according to a first embodiment of the present invention.

FIG. 2 is a plan view of the fiber module of FIG. 1.

FIG. 3 is a plan view of an optical fiber used in the fiber module of FIG. 1.

FIG. 4 is a side view of the fiber module of FIG. 1 after reinforcement.

FIG. 5 is a plan view of a fiber module according to a second embodiment of the present invention.

FIG. 6 is a plan view of a fiber module according to a third embodiment of the present invention.

FIG. 7 is a plan view of a fiber module according to a fourth embodiment of the present invention.

FIG. 8 is a plan view of a fiber module according to a fifth embodiment of the present invention.

FIG. 9 is a cross-sectional side view of the main portion of a fiber module according to a sixth embodiment of the present invention.

FIG. 10 is a plan view of another example of an optical fiber used in the present invention.

### DESCRIPTION OF THE PREFERRED EMBODIMENTS

Embodiments of the present invention are explained in detail below with reference to the attached drawings.

### First Embodiment

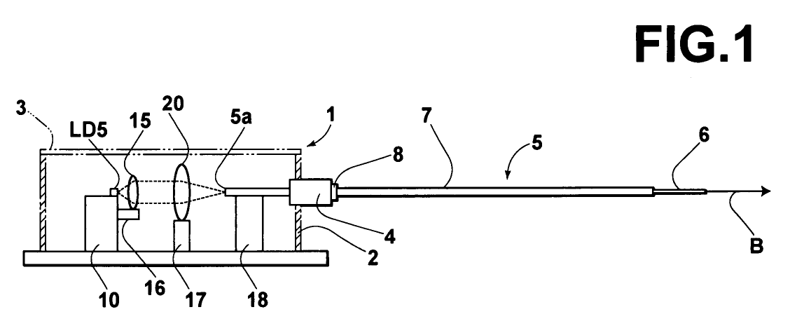

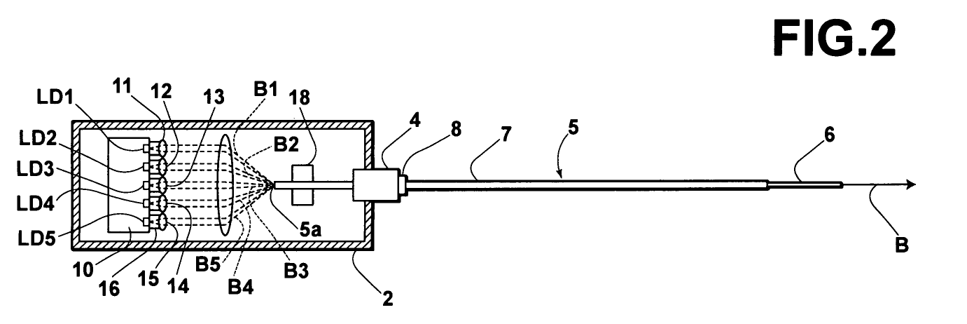

FIG. 1 is a side view of a fiber module according to a first embodiment of the present invention, and FIG. 2 is a plan view of the fiber module of FIG. 1.

The example of the fiber module illustrated in FIG. 1 realizes an optically-multiplexing laser-light source, and comprises a package 1 having a structure which allows sealing of the inside of the package, and a multimode optical fiber 5 having a predetermined length and being fixed to the package 1 in such a manner that an end 5a of the optical fiber 5 protrudes inside the package 1.

The package 1 is constituted by a package body 2 having a box shape and an opening on the upper side, and a package cover 3 with which the opening is closed. In addition, a hollow sleeve 4 is fixed to a sidewall of the package body 2. The package cover 3 is not shown in FIG. 2.

The cladding of the optical fiber 5 is exposed (bare) in a vicinity 6 of the other end of the optical fiber 5, and coated with a metal in the other portion 7 of the optical fiber 5. That is, the optical fiber 5 has a bare portion 6 and a metalized portion 7. A portion of the optical fiber 5 in a vicinity of the end 5a passes through and is fixed to a ferrule 8, and the ferrule 8 is fixed to the sleeve 4, which is fixed to the package body 2. Thus, the optical fiber 5 is fixed to the package body 2. The optical fiber 5 may be a step-index type, a graded-index type, or any combination thereof. Alternatively, a single-mode optical fiber may be used instead of the multimode optical fiber.

Next, elements arranged in the package 1 are explained below.

A heat sink 10 made of copper is fixed to the bottom plate of the package 1, and a plurality of GaN-based semiconductor laser chips LD1 through LD5 are fixed on the upper surface of the heat sink 10. For example, the number of the GaN-based semiconductor laser chips LD1 through LD5 is five, and the five GaN-based semiconductor laser chips LD1 through LD5 each operate in a multiple transverse modes. In addition, a collimator-lens holder 16 is also fixed to the heat sink 10, and collimator lenses 11 through 15 are fixed on the collimator-lens holder 16 so that the light-emission axes of the GaN-based semiconductor laser chips LD1 through LD5 coincide with the optical axes of the collimator lenses 11 through 15, respectively.

Further, a condensing-lens holder 17 and a fiber holder 18 are fixed on the bottom plate of the package 1, a condensing lens 20 is fixed on the condensing-lens holder 17, and an end portion of the optical fiber 5 is fixed on the fiber holder 18.

The GaN-based semiconductor laser chips LD1 to LD5 each have an oscillation wavelength of approximately 408 nm and a maximum output power of approximately 100 mW. Note that in the present embodiment, lasers having oscillation wavelengths in the range of 403 to 415 nm are employed. Divergent laser beams B1 to B5 emitted from the GaN-based semiconductor laser chips LD1 to LD5 are respectively collimated by collimator lenses 11 through 15. Then, the collimated laser beams B1 to B5 are collected by the condensing lens 20, and converge on an end face of a core of the multimode optical fiber 5 at the end 5a. Thus, the laser beams B1 to B5 enter and propagate in the core of the multimode optical fiber 5, in which the laser beams B1 to B5 are optically multiplexed into a single laser beam B. Finally, the laser beam B is outputted from an end face at the other end of the optical fiber 5. In this example, the coupling efficiency of the collimated laser beams B1 to B5 to the optical fiber 5 is 0.9. Since the GaN-based semiconductor laser chips LD1 through LD5 each have an output power of approximately 100 mW, the optically-multiplexed laser beam B has an output power of approximately 450 mW (=100 mW×0.9×5).

Hereinbelow, a method for producing the fiber module according to the first embodiment is explained.

First, a single, multimode optical fiber which is covered with only a primary coating is cut into a section having a length of 140 mm, and the primary coating of the section is removed with a coating-removing agent so as to obtain a bare optical fiber, in which the cladding is exposed by the removal of the primary coating. Then, a first portion of the bare optical fiber including an end and having a length of 100 mm is placed in an evaporation furnace, and thin films of nickel and titanium are formed by evaporation on the cladding in the first portion.

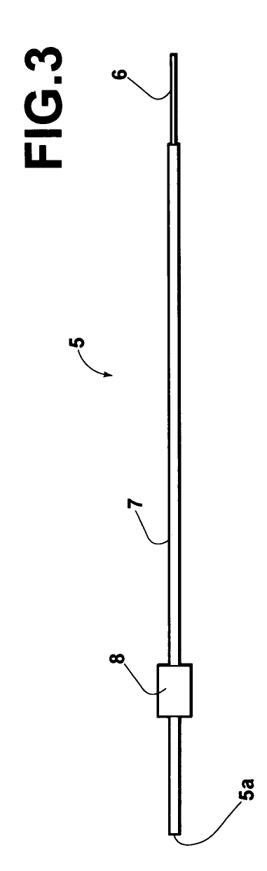

Thereafter, the optical fiber is dipped into a plating bath for gold plating so as to metalize the side surface of the first portion of the optical fiber. At this time, the other (second) portion of the optical fiber having a length of 40 mm is protected with a jig or a resin so as not to be metalized during the metalizing process, and the jig or resin is removed after completion of the metalizing process. Thereafter, a gold-plated metal ferrule is fixed to the metalized portion 7 of the optical fiber by soldering. Thus, as illustrated in FIG. 3, the optical fiber 5 used in the fiber module according to the first embodiment includes the bare portion 6 and the metalized portion 7, where the ferrule 8 is fixed to the metalized portion 7.

The end of the bare portion 6, which is to be coupled to another optical fiber by fusion, is cut so that the end face becomes a mirror surface. In addition, the opposite end 5a of the optical fiber 5, from which the laser beams emitted from the semiconductor lasers enter the optical fiber 5, is also cut so that the end face at the end 5a becomes a mirror surface in order to achieve optical coupling with high efficiency. Further, the end face at the end 5a may be polished, and an antireflection coating for the wavelength of the used light (i.e., approximately 408 nm in this example) may be provided. Although the end 5a in the first embodiment protrudes from the sidewall of the package body 2, the end 5a of the optical fiber may be flush with or slightly recessed from the inner surface of the sidewall.

On the other hand, the hollow sleeve 4 and terminals for conductive connections (not shown) are attached to the sidewall of the package body 2. The upper side of the package body 2 is open, and the entire surfaces of the package body 2 and the package cover 3 are plated with gold. The optical fiber 5 is inserted through the sleeve 4 so that the end 5a protrudes inside the package body 2, and is fixed to the package body 2 by fixing the ferrule 8 to the sleeve 4 by soldering so that the gap between the sleeve 4 and the ferrule 8 is solder sealed.

Then, the GaN-based semiconductor laser chips LD1 through LD5 are wire-bonded to the above terminals, and the GaN-based semiconductor laser chips LD1 through LD5, the collimator lenses 11 through 15, and the condensing lens 20 are aligned with each other so that the laser beams B1 to B5 emitted from the GaN-based semiconductor laser chips LD1 through LD5 converge on the end face of the core of the optical fiber 5 at the end 5a, and fixed to each other with soldering, welding, or using a very small amount of an adhesive. Note that in the case that the fixing is performed employing solder, it is desirable to employ flux free solder. In the case that adhesive is employed, it is desirable to employ an adhesive that does not contain Si organic materials. If a resin coating remains in the bare portion 6 of the optical fiber 5 which is located outside the package body 2, the remaining resin coating is completely removed by chemical etching or mechanical stripping.

Thereafter, in order to remove volatile components in the package 1 (which cause deterioration of the long-term reliability of the laser) after the optical coupling is achieved, the entire module is placed in a furnace in a degassing system, and a degassing operation is performed by heating the module to 90° C. in an atmosphere to be explained below. After the degassing operation, the package cover 3 is fixed to the upper side of the package body 2 by welding or soldering so that the package 1 is sealed. Thus, the inside of the package 1 is filled with the above atmosphere.

It is preferable that the above atmosphere is inert gas. A preferable inert gas with which the package 1 is filled is nitrogen, a noble gas, or the like. It is further preferable that the above inert gas contains at least one of oxygen of at least 1 ppm, halogen gas, and halide gas.

When oxygen of at least 1 ppm is contained in the sealed atmosphere, deterioration of the fiber module can be more effectively suppressed. This improvement in deterioration suppression is because the oxygen contained in the sealed atmosphere oxidizes and decomposes solid materials generated by photodecomposition of hydrocarbon components. Alternatively, in order to contain oxygen in the sealed atmosphere, it is possible to add clean air (the components of the atmosphere).

The halogen gas includes chlorine (Cl₂) gas, fluorine (F₂) gas, and the like, and the halide gas are gaseous compounds containing a halogen atom such as chlorine (Cl), bromine (Br), iodine (I), or fluorine (F).

The halide gas includes CF₃Cl, CF₂Cl₂, CFCl₃, CF₃Br, CCl₄, CCl₄—O₂, C₂F₄Cl₂, C₁—H₂, PCl₃, CF₄, SF₆, NF₃, XeF₂, C₃F₈, CHF₃, and the like. Compounds of fluorine or chlorine with carbon (C), nitrogen (N), sulfur (S), or xenon (Xe) are preferable for use in the present invention, and compounds containing the fluorine atom are particularly preferable.

Although inclusion of even a very small amount of halogen or halide gas produces the effect of suppressing the deterioration of the laser, in order to make the effect remarkable, it is preferable that the concentration of halogen or halide gas in the sealed atmosphere is 1 ppm or more. The inclusion of halogen or halide gas in the sealed atmosphere suppresses the deterioration of the laser because the halogen or halide gas in the sealed atmosphere decomposes materials deposited by photodecomposition of organic silicon compound gas.

Since no resin coating remains in the optical fiber 5 as explained before, the inside of the package is not contaminated with a component exhaled from the resin coating during the degassing operation. Therefore, it is possible to prevent contamination of the collimator lenses 11 through 15, the condensing lens 20, and the end 5a of the optical fiber 5 in the package, enhance operational stability and reliability, and stably maintain the output power of the optically-multiplexed laser beam B high. In particular, the above effects are pronounced in the above example since the oscillation wavelengths of the GaN-based semiconductor laser chips LD1 through LD5 are in the vicinity of approximately 408 nm, which is in the wavelength range of 350 to 500 nm (i.e., the wavelength range in which the elements in the package are generally prone to contamination).

The major portion of the optical fiber 5 is the metalized portion 7, which is coated with a metal. That is, the optical fiber 5 is reinforced and protected by the metal coating during use, and damage or breakage of the optical fiber 5 can be effectively prevented.

In addition, since substantially no component is exhaled from the coating of the optical fiber during the degassing operation, the partial pressure of components exhaled in the degassing system is reduced, and the effect of the degassing operation is enhanced. Specifically, the partial pressure of the exhaled components becomes 1×10⁻⁸ Torr in the first embodiment, while the partial pressure of exhaled components becomes as high as 1×10⁻⁴ Torr in the case where the resin coating of the optical fiber exists in the degassing system. That is, the advantage of the present invention is clear.

The optical fiber 5 which is metalized as above can be produced at lower cost than the aforementioned optical fiber using polyimide as a coating material. Therefore, the fiber module according to the first embodiment using the above optical fiber 5 can be produced without substantial increase in cost, i.e., at a relatively low cost.

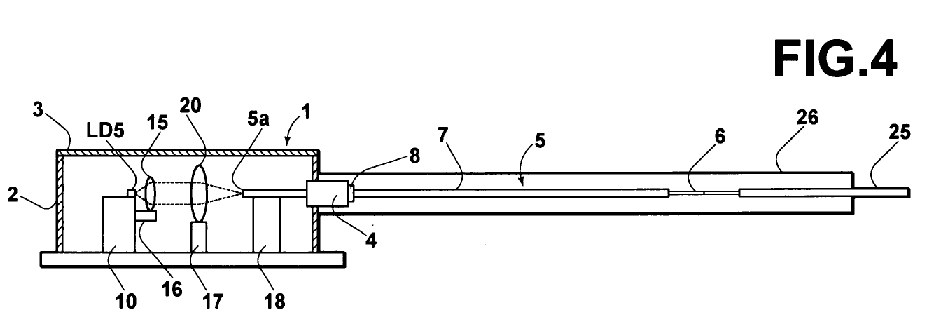

After the inside of the package 1 is sealed, another optical fiber which is covered with the conventional organic coating is joined, by fusion, with the bare portion 6 of the optical fiber 5, which extends outside the package body 2. FIG. 4 shows a construction of the fiber module in which another optical fiber 25 is connected. In the case where the conventional optical fiber 25 is coupled to the fiber module as above, thereafter, a desired optical fiber having a necessary length can be easily coupled to the conventional optical fiber 25 by using the conventional fusion splicer.

In addition to the above, in order to reinforce the optical fibers, it is preferable to cover a portion of the sidewall of the package body 2 around the sleeve 4, the metalized portion 7, a fused portion in the bare portion 6, and portions of the optical fibers 5 and 25 in a vicinity of the fused portion, with a tube 26 made of a resin, a heat contraction material, nylon, or the like (as illustrated in FIG. 4). Instead of the tube 26, the reinforcement may be realized by a support member being made of a resin or an inorganic material such as a metal or a ceramic material and having a cylindrical or semicylindrical shape. Alternatively, the reinforcement may be realized by a support member having a V-groove on which optical fibers can be placed.

The metalized portion 7 is less advantageous than the conventional optical fibers having the primary and secondary coatings in the tensile strength and the effect of suppressing damage, and the bare portion 6 is prone to break. However, when the metalized portion 7 and the bare portion 6 are reinforced as mentioned above by using the tube 26 or the like, the optical fiber becomes unlikely to break during normal use.

Although it is preferable to minimize the length of the optical fiber 5, in order to produce the fiber module at low cost, it is necessary that the operation of fusion splicing by use of a conventional fusion splicer can be performed. For example, in the case where the fusion splicing is performed by using the fusion splicer S175 manufactured by Furukawa Electric Co., Ltd., it is preferable that the length of the metalized portion 7 in the optical fiber 5 located outside the package is 65 to 75 mm. In addition, it is preferable that no foreign material exists in a region at which the temperature rises at the time of fusion, and the length of the metalized portion 7 in the optical fiber 5 located outside the package is minimized in order to maintain the strength. For example, the preferable length of the metalized portion 7 outside the package is about 2 to 40 mm.

In the fiber modules according to the present invention, it is sufficient that the portion of the optical fiber 5 in the vicinity of the external end (which is to become the bare portion 6, in which the cladding is exposed) is required to be bare only at the time of degassing. Therefore, it is possible to leave the original coating of the portion of the optical fiber 5 in the vicinity of the external end until the degassing is performed, in order to prevent damage which can occur during the operations performed before the degassing. In this case, for example, in order to realize the dimensions of the optical fiber mentioned before, the optical fiber 5 can be produced as follows.

A single, multimode optical fiber as mentioned before is cut into a section having a length of 140 mm, and the primary coating in a portion of the optical fiber including an end and having a length of 40 mm is left, and the primary coating in the other portion of the optical fiber including the other end and having a length of 100 mm is removed. Then, the aforementioned evaporation of thin metal films and metalization of the sidewall are performed on the portion having the length of 100 mm. Thereafter, the aforementioned operations in the method according to the first embodiment before the degassing are performed, and the primary coating in the portion having the length of 40 mm is removed immediately before the degassing process.

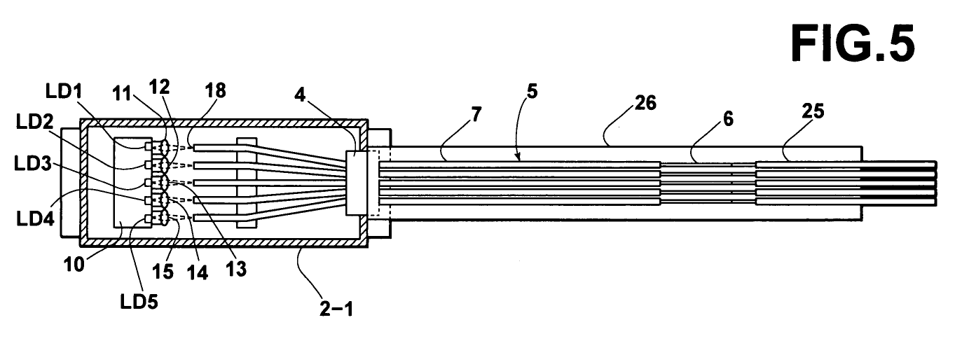

Hereinbelow, the second to sixth embodiments of the present invention are explained with reference to FIGS. 5 to 9. Elements in FIGS. 5 to 9 which are respectively equivalent to elements in FIGS. 1 to 4 bear the same reference numbers as the corresponding elements in FIGS. 1 to 4, and explanations of the equivalent elements are not repeated unless necessary. In addition, in each of FIGS. 5 to 8, the package cover 3 is not shown. Further, in each of the second to fifth embodiments, another optical fiber 25 is coupled to the optical fiber 5, and the optical fiber 5 and a fused portion are reinforced with a tube 26. The optical fiber 25 and the tube 26 are arranged after the degassing in a similar manner to the first embodiment.

### Second Embodiment

FIG. 5 is a plan view of a fiber module according to the second embodiment of the present invention.

The fiber module according to the second embodiment is basically identical to the first embodiment except that five optical fibers 5 are provided in correspondence with the five GaN-based semiconductor laser chips LD1 through LD5 so that the laser beams emitted from the GaN-based semiconductor laser chips LD1 through LD5 enter the five optical fibers 5, respectively.

Since the fiber module according to the second embodiment also uses the optical fibers 5 each having the bare portion 6 and the metalized portion 7 which are similar to the corresponding elements illustrated in FIG. 3, the fiber module according to the second embodiment has similar advantages to the first embodiment.

### Third Embodiment

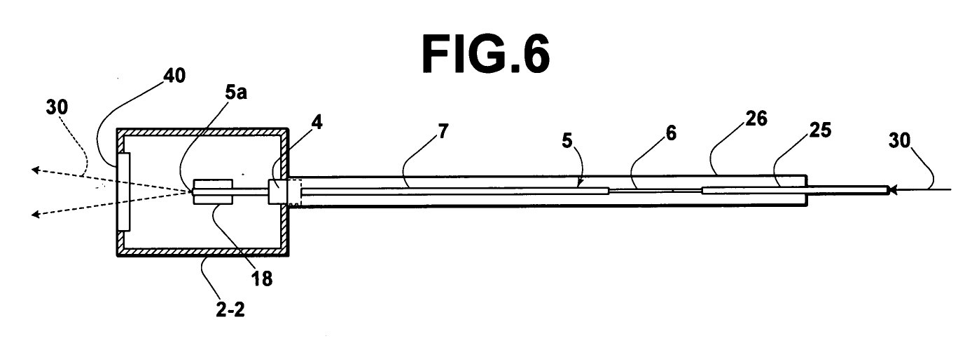

FIG. 6 is a plan view of a fiber module according to the third embodiment of the present invention.

In the fiber module according to the third embodiment, a light beam 30 which is emitted from a light source (not shown) located outside the fiber module enter the optical fiber 25, which is coupled to the bare portion 6 of the optical fiber 5. Then, the light beam 30 propagates through the optical fiber 25 and the optical fiber 5, is emitted from the end 5a, passes through a transparent window 40 formed in a package body 2-2, and is be outputted from the fiber module. The other portions of the fiber module according to the third embodiment are basically identical to the corresponding portions of the first embodiment.

In the third embodiment, a portion of the optical fiber 5 in a vicinity of the end 5a is contained in a package constituted by the package body 2-2 and a package cover (not shown) and provided for protection. In addition, since the fiber module according to the third embodiment also uses the optical fiber 5 having the bare portion 6 and the metalized portion 7 which are similar to the corresponding elements illustrated in FIG. 3, the fiber module according to the third embodiment has similar advantages to the first embodiment.

### Fourth Embodiment

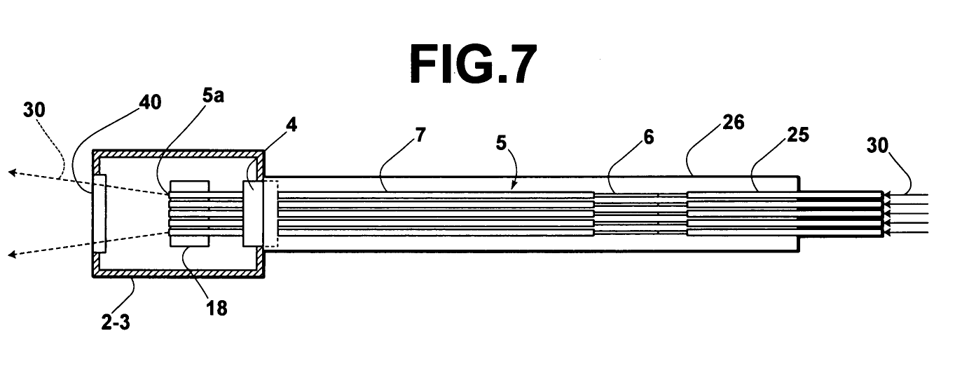

FIG. 7 is a plan view of a fiber module according to the fourth embodiment of the present invention.

The fiber module according to the fourth embodiment is basically identical to the third embodiment (illustrated in FIG. 6) except that five optical fibers 5 are provided, and optical fibers 25 are coupled with the five optical fibers 5, respectively.

In the fourth embodiment, a portion of each optical fiber 5 in a vicinity of the end 5a is contained in a package constituted by a package body 2-3 and a package cover (not shown) and provided for protection. In addition, since the fiber module according to the fourth embodiment also uses the optical fibers 5 each having the bare portion 6 and the metalized portion 7 which are similar to the corresponding elements illustrated in FIG. 3, the fiber module according to the fourth embodiment has similar advantages to the first embodiment.

### Fifth Embodiment

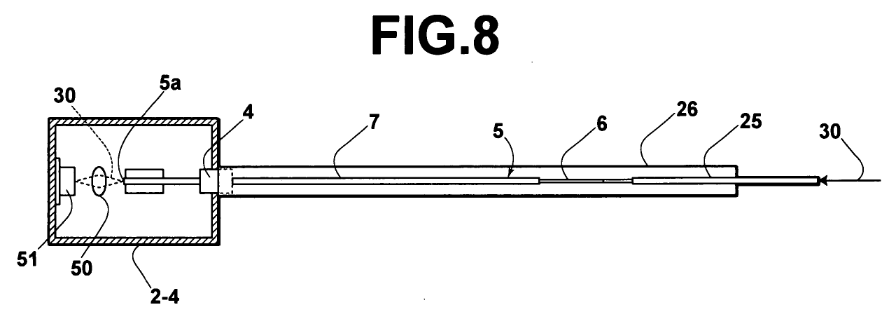

FIG. 8 is a plan view of a fiber module according to the fifth embodiment of the present invention.

The fiber module according to the fifth embodiment is basically identical to the third embodiment (illustrated in FIG. 6) except that the light beam 30 emitted from the end 5a is collected by a condensing lens 50, and enters a light-receiving element 51 (e.g., a photodiode) so that the light beam 30 is detected by the light-receiving element 51.

In the fifth embodiment, a portion of the optical fiber 5 in a vicinity of the end 5a, the condensing lens 50, and the light-receiving element 51 are contained in a package constituted by a package body 2-4 and a package cover (not shown) and provided for protection. In addition, since the fiber module according to the fifth embodiment also uses the optical fiber 5 having the bare portion 6 and the metalized portion 7 which are similar to the corresponding elements illustrated in FIG. 3, the fiber module according to the fifth embodiment has similar advantages to the first embodiment.

### Sixth Embodiment

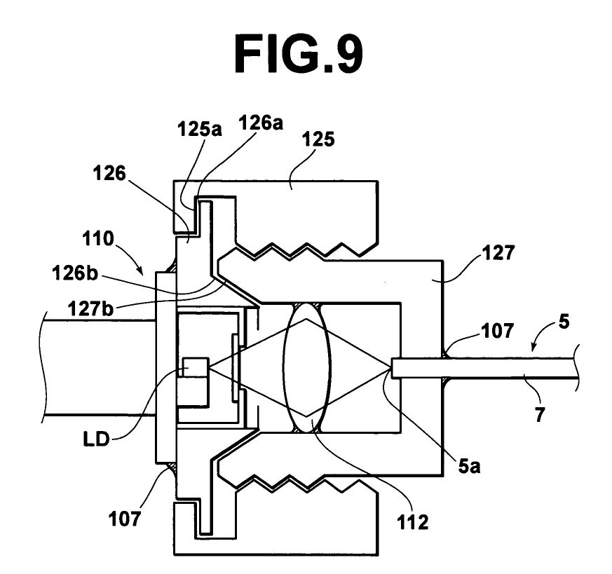

FIG. 9 is a cross-sectional side view of the main portion a fiber module according to the sixth embodiment of the present invention.

The fiber module according to the sixth embodiment has a construction in which light emitted from a light-emitting element arranged in a package enters an optical fiber. The fiber module according to the sixth embodiment is different from the first embodiment in that a can-packaged semiconductor laser is used instead of the chip-type semiconductor lasers.

Hereinbelow, the construction of the fiber module according to the sixth embodiment is explained in detail.

The package used in the fiber module according to the sixth embodiment has a sealing structure using a metal sleeve 125. Specifically, the package comprises the metal sleeve 125, a holder 126, and a cylinder 127. The inner surface of the metal sleeve 125 is threaded. The holder 126 is provided for holding a can package 110 containing a semiconductor laser chip LD, and has a flange having a face 126 which is to abut on a portion 125a of the metal sleeve 125. The cylinder 127 encloses a condensing lens 112, and the outer surface of the cylinder 127 is threaded.

When the metal sleeve 125 is screwed on the cylinder 127 in such a manner that the above portion 125a of the metal sleeve 125 abuts on the face 126 of the flange, the cylinder 127 is pressed to the holder 126, and the beveled surfaces 127b and 126b of the cylinder 127 and the holder 126 become in contact with each other. Thus, the internal space of the package is sealed.

On the other hand, the optical fiber 5 is inserted through a hole arranged through the bottom of the cylinder 127, and fixed with, for example, an inorganic adhesive 107 so that the gap between the optical fiber 5 and the cylinder 127 is sealed. In addition, the can package 110 is fixed to the holder 126 with, for example, the inorganic adhesive 107.

Since the fiber module according to the sixth embodiment also uses the optical fiber 5 having the bare portion 6 and the metalized portion 7 which are similar to the corresponding elements illustrated in FIG. 3 (although the ferrule 8 is unnecessary), the fiber module according to the sixth embodiment has similar advantages to the first embodiment.

### Variations and Additional Matters

(i) Although each portion 7 of the optical fiber 5 (other than the bare portion 6) is coated with metal in each of the first to sixth embodiments, the portion 7 may be coated with an inorganic material instead of metal. In this case, the fiber module also has similar advantages to the case where the portion 7 is coated with metal.

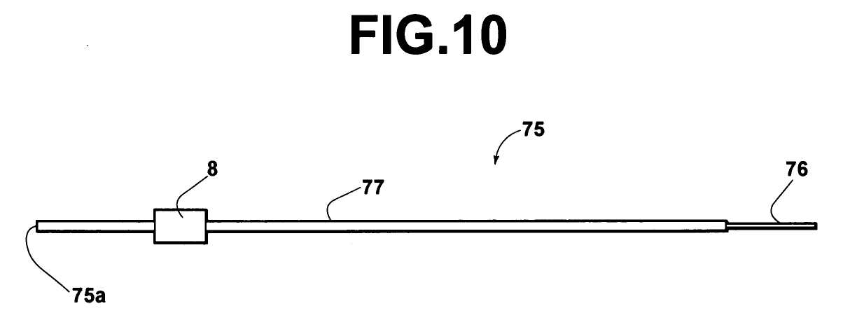

FIG. 10 shows an example of an optical fiber which is coated with an inorganic material except for the bare portion 6. The optical fiber 75 illustrated in FIG. 10 is formed by inserting a bare optical fiber 76 into a tube 77, and fixing the bare optical fiber 76 to the tube 77. The cladding of the bare optical fiber 76 is exposed through its entire length. The tube 77 is made of an inorganic material, and has an internal diameter slightly greater than the external diameter of the bare optical fiber 76, and a length smaller than the bare optical fiber 76. Therefore, after the insertion and fixture of the bare optical fiber 76, a portion of the bare optical fiber 76 having a predetermined length is left exposed. In addition, when necessary, a ferrule 8 is fixed to the optical fiber 75 at a position near an end 75a of the optical fiber 75. Preferably, the inorganic material of which the tube 77 is made is, for example, a glass or ceramic material.

The present invention is not limited to employing the discrete single cavity semiconductor laser elements provided in an array which were described in the above embodiment, as the semiconductor elements which are contained within the package. Alternatively, a single multi cavity semiconductor laser element (an LD bar), a plurality of multi cavity semiconductor laser elements provided in an array, or combinations of single cavity semiconductor laser elements and multi cavity semiconductor laser elements may be employed.

Single mode semiconductor laser elements having aperture sizes of 1 to 3 um, multimode semiconductor laser elements having aperture sizes of 2 to 30 um, and broad area semiconductor laser elements having aperture sizes of 30 to 50 um may be utilized as the semiconductor laser elements.

(ii) In addition, all of the contents of the Japanese patent application No. 2003-024889 are incorporated into this specification by reference.

What is claimed is:

1. A fiber module comprising:
a package having a structure which allows sealing of an inside of the package; and
an optical fiber having a cladding, first and second ends, and a predetermined length, and being fixed to said package in such a manner that the first end of the optical fiber appears inside the package;
wherein said cladding is exposed in a vicinity of the second end, and the optical fiber other than a portion of the cladding in said vicinity is coated with at least one of a metal and an inorganic material.

2. A fiber module comprising:
a package having a structure which allows sealing of an inside of the package; and
an optical fiber having a cladding, first and second ends, and a predetermined length, and being fixed to said package in such a manner that the first end of the optical fiber appears inside the package;
wherein said cladding is exposed in the vicinities of the first and second ends, and the optical fiber other than a portion of the cladding in said vicinities is coated with at least one of a metal and an inorganic material.

3. A fiber module according to claim 1, wherein the package is hermetically sealed by flux free solder, an adhesive that does not contain Si organic materials, by fusion, or by welding.

4. A fiber module according to claim 2, wherein the package is hermetically sealed by flux free solder, an adhesive that does not contain Si organic materials, by fusion, or by welding.

5. A fiber module according to claim 1, wherein the interior of the package is filled with an inert gas.

6. A fiber module according to claim 2, wherein the interior of the package is filled with an inert gas.

7. A fiber module according to claim 5, wherein the inert gas includes at least one of a halogen gas, a halide gas, and oxygen at a concentration of 1 PPM or greater.

8. A fiber module according to claim 6, wherein the inert gas includes at least one of a halogen gas, a halide gas, and oxygen at a concentration of 1 PPM or greater.

9. A fiber module according to claim 1, further comprising:
light emitting elements and/or light receiving elements; wherein
the light emitting elements and/or the light receiving elements are optically connected to an end of the optical fiber.

10. A fiber module according to claim 2, further comprising:
light emitting elements and/or light receiving elements; wherein
the light emitting elements and/or the light receiving elements are optically connected to an end of the optical fiber.

11. A fiber module according to claim 9, wherein said package contains,
a plurality of semiconductor lasers, for emitting a plurality of laser beams, provided as said light-emitting elements,
a plurality of collimator lenses which collimate the plurality of divergent laser beams emitted from the plurality of semiconductor lasers, respectively, and
a condensing lens which condenses the collimated laser beams, and makes the collimate laser beams converge on an end face of a core of the optical fiber at said first end.

12. A fiber module according to claim 10, wherein said package contains,
a plurality of semiconductor lasers, for emitting a plurality of laser beams, provided as said light-emitting elements,
a plurality of collimator lenses which collimate the plurality of divergent laser beams emitted from the plurality of semiconductor lasers, respectively, and
a condensing lens which condenses the collimated laser beams, and makes the collimate laser beams converge on an end face of a core of the optical fiber at said first end.

13. A fiber module according to claim 11, wherein the semiconductor lasers are one of:
a plurality of single cavity semiconductor laser elements aligned in an array;
a single multi cavity semiconductor laser element;
a plurality of multi cavity semiconductor laser elements aligned in an array; and
a combination of single cavity semiconductor laser elements and multi cavity semiconductor laser elements.

14. A fiber module according to claim 12, wherein the semiconductor lasers are one of:
a plurality of single cavity semiconductor laser elements aligned in an array;
a single multi cavity semiconductor laser element;
a plurality of multi cavity semiconductor laser elements aligned in an array; and
a combination of single cavity semiconductor laser elements and multi cavity semiconductor laser elements.

15. A fiber module according to claim 11, wherein said plurality of semiconductor lasers have an oscillation wavelength of 350 to 500 nm.

16. A fiber module according to claim 12, wherein said plurality of semiconductor lasers have an oscillation wavelength of 350 to 500 nm.

17. A fiber module according to claim 13, wherein said plurality of semiconductor lasers have an oscillation wavelength of 350 to 500 nm.

18. A fiber module according to claim 14, wherein said plurality of semiconductor lasers have an oscillation wavelength of 350 to 500 nm.

19. A method for producing a fiber module which includes a first optical fiber having a cladding, first and second ends, and a predetermined length, comprising the steps of:
(a) exposing a portion of said cladding in a vicinity of the second end, and coating the first optical fiber other than said portion with at least one of a metal and an inorganic material;
(b) fixing said first optical fiber to a package having a structure which allows sealing of an inside of the package, in such a manner that the first end of the first optical fiber appears inside the package;
(c) degassing the inside of the package; and
(d) hermetically sealing the package.

20. A method for producing a fiber module which includes a first optical fiber having a cladding, first and second ends, and a predetermined length, comprising the steps of:
(a) exposing a portion of said cladding in a vicinity of the second end, and coating the first optical fiber other than said portion with at least one of a metal and an inorganic material;
(b) fixing said first optical fiber to a package containing either light-emitting elements or light-receiving elements and having a structure which allows sealing of an inside of the package, in such a manner that the first end of the first optical fiber appears inside the package, and said first optical fiber is optically coupled to said at least one of light-emitting elements and light-receiving elements at said first end;
(c) degassing the inside of the package; and
(d) hermetically sealing the package.

21. A method according to claim 19, further comprising the step of coupling said second end of the first optical fiber to a second optical fiber being coated with a resin and having a predetermined length, after said step (d).

22. A method according to claim 20, further comprising the step of coupling said second end of the first optical fiber to a second optical fiber being coated with a resin and having a predetermined length, after said step (d).

23. A method according to claim 21, further comprising the step of at least partially reinforcing a portion of the fiber module between a wall of the package and the second optical fiber by using a reinforcing member.

24. A method according to claim 22, further comprising the step of at least partially reinforcing a portion of the fiber module between a wall of the package and the second optical fiber by using a reinforcing member.
